(19) United States
(12) Patent Application Publication
(10) Pub. No.: US 2025/0084311 A1
(43) Pub. Date: Mar. 13, 2025

(54) HYDROGEL COMPOSITIONS FOR STABILIZATION OF SOILS

(71) Applicant: Intelligent Concrete, LLC, Elbert, CO (US)

(72) Inventors: Jonathan S. Belkowitz, Elbert, CO (US); WhitneyLe Bitter Belkowitz, Elbert, CO (US); Eric A. Tyrrell, Elbert, CO (US)

(21) Appl. No.: 18/825,771

(22) Filed: Sep. 5, 2024

Related U.S. Application Data
(60) Provisional application No. 63/581,037, filed on Sep. 7, 2023.

(51) Int. Cl. C09K 17/42; E02D 3/12

(52) U.S. Cl. CPC C09K 17/42; E02D 3/12

(57) ABSTRACT

A method of soil includes applying a composition to soil to form treated soil, wherein the composition comprises nanosilica in an aqueous suspension, and the treated soil exhibits reduced erosion, reduced swelling and shrinking capacity and increased unconfined uniaxial compressive strength and shear strength compared to soil without the composition.

### CROSS-REFERENCE TO RELATED APPLICATIONS

This application is an International Patent Application claiming priority to and the benefit of U.S. Provisional Application No. 63/581,037, filed on Sep. 7, 2023, and which is incorporated herein by reference in its entirety.

### FIELD

The present technology is generally related to compositions for stabilizing and strengthing soils.

### SUMMARY

In one aspect, a method of treating soil includes applying a nanosilica composition to soil to form a treated soil to saturate the soil and allowing it to cure and harden. The compositions include nanosilica in an aqueous suspension. In some embodiments, a first nanosilica composition having a first particle size is applied along with or prior to a second nanosilica composition having a second particle size, wherein the first particle size is larger than the second particle size. In other embodiments, a first coated nanosilica composition is applied prior to or along with a non-coated nanosilica composition. In some embodiments, the applying includes injecting or mixing the nanosilica composition into the soil. In some embodiments, the applying includes injecting the nanosilica composition into the soil with a series of salts. The methods and compositions provide an environmentally friendly technology for the stabilization of soil.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In one aspect, a composition is provided for treating soil to improve soil properties, reduce or eliminate soil erosion, stabilize soil expansion, shrinkage, heave, consolidation, and reduce permeability. The compositions also provide the soil with an increased unconfined compressive strength and shear strength compared to the soil prior to application of the composition. As used herein, the phrase “unconfined compressive strength” is intended to refer to the maximum axial compressive stress that a soil sample can bear under zero confining stress. The unconfined compressive strength may be measured according to ASTM D 1633-17, permeability according to ASTM D 2434, and shear strength according to ASTM D 3080.

The composition is a hydrogel composition includes a nanosilica solution that is a treatment that penetrates and disperses through the soil. As the composition cures in the soil, it binds the soil together to hold it in place while allowing water and nutrients to continue to penetrate through the treated soil and into support the soil and ground underneath. The compositions may be injected into the soil.

In another aspect, a composition is provided comprising nanosilica in an aqueous solution that is configured to be applied to, and thereby penetrate and disperse into, soil. In some embodiments, the compositions are injected into the soil. Without being bound by theory, it is believed that the nanosilica composition reacts with calcium hydroxide and other salts in the soil and soil-pore water solution.

The nanosilica has a particle size from about 1 nm to about 1000 nm. The particle size distribution of the nanosilicas used can range from small nanosilica particles with narrow distributions of 1-3 nm, 3-5 nm, 6-8 nm, 10-12 nm, 17-19 nm and wide distributions of 3-10 nm, 3-20 nm, 5-20 nm and other variation of these narrow and wide particle size distributions. The particle size distribution of the nanosilicas used can range from large nanosilica particles with narrow distributions of 45-47 nm, 50-55 nm, 70-75 nm, and wide distributions of 3-100 nm, 50-75 nm, 100-500 nm and other variation of these narrow and wide particle size distributions.

The nanosilica particles in the nanosilica may have a variety of shapes from spherical, elliptical, cylindrical, and irregular. The type of shape used is normally spherical for the embodiments but particle size changes to elliptical or elongated as the particles become larger. This change in particle shape can be beneficial in different embodiments to promote reduction in permeability through particle-to-particle packing, pore blocking, and hydrogel-development.

The nanosilica may be present in the composition over a range of concentrations. The solids content of the nanosilica can range from 50% solids and below. The pH of the nanosilica can range from acidic (less than 4 and up to 7), neutral (7), to basic (7 and above). The pH of these nanosilica treatments without additions listed above should not exceed 10.7.

The nanosilica particles may also be coated with other materials that may provide other properties to the compositions. For example, coated nanosilica particles such as, but not limited to, alumina modified nanosilica, is believed to react more slowly with the calcium hydroxide, other salts, and contaminants in the soil thereby allowing for deeper penetration into the soil. Additionally, the coatings may induce other reactions besides just the neutralization of the calcium hydroxide, other salts, and contaminants. For example, other reactions include, but are not limited to, the alumina modified nanosilica reacting to form calcium alumina silicate hydrate and calcium-silicate-hydrate. Illustrative coatings include, but are not limited to, alumina. The nanosilica particles can be non-modified surfaces that are stabilized in solution with sodium oxide, potassium oxide and other forms of salts that create an electrical double layer at the surface of the particle. Other embodiments include nanosilica-sized particles stabilized with: alumina, lithia, silica, and then stabilized with a salt such as sodium oxide. There may be multiple modifications on one nanosilica-sized particle.

As noted above, other additives may be included in the compositions as well. For example, the compositions may be polymer modified, include surfactants, silicates, hydrophobic materials, degreasers, dispersants, and stabilizers for the nanosilica to include. Illustrative polymers include, but are not limited to polycarbonates, poly(meth)acrylates, glycol ethers, poly-carboxylates comb polymers, and the like. Other additives may include graphene, carbon nanotubes, nano alumina, nano titanium dioxide, and nano copper.

The additive may be present from about less than 1 wt % to below 50 wt % of the total weight of the composition.

In another aspect, a method of application of the compositions described above to soil is provided herein. The compositions may be sprayed on, mixed into, or poured on, or injected vertically and horizontally into, the soil. From time zero, when the composition is applied to the soil, the nanosilica combines with water in the soil. The water in the soil typically contains soluble alkalis, hydroxides, sulfates, chlorides, and other materials that can react with the nanosilica compositions. Following application of the nanosilica composition, the nanosilica and additive consume the soluble alkali, hydroxides, sulfates, chlorides to generate a hydrogel. Over time, as the hydrogel matures and branches, it gains in size and rigidity through polymerization of the silica particles and provides structure and body to the soil.

In another illustration of the application, the composition may be mixed into the soil in and around a concrete foundation for a structure, or with low-strength cement stabilized soil. In some embodiments, the application to the soil is through injection of the composition(s). For such mixing or injection, the soil may be analyzed for permeability (ASTM D 2434), moisture (ASTM D 2216), and salt type and content (ASTM D 4522). For less permeable soils with high salt content, compositions compositions including an alumina-modified nanosilica may be used. The lower the permeability of the soil, smaller the particle size is needed to migrate through the inter-connected pores of the soil. The higher the degree of salts present, the higher the tendency for the descrete nano silica particles in the dispersion will destabilize and start forming a hydrogel around and throughout the soil and pore solution. Treated or coated nano silica (alumina, lithium, silane, copper) will offer other performance features (binding salts, hydrophobic, and antimicrobial) as well as slow down the destabilization process of the nano particles.

The composition may then be applied to the soil in successive applications at a rate of about 5000 square feet per gallon (“sfpg”) to about 10 sfpg. This may include from about 4000 sfpg to about 10 sfpg, from about 3000 sfpg to about 10 sfpg, from about 2500 sfpg to about 10 sfpg, from about 1000 sfpg to about 10 sfpg, from about 5000 sfpg to about 50 sfpg, from about 2500 sfpg to about 50 sfpg, from about 1000 sfpg to about 50 sfpg, from about 5000 sfpg to about 100 sfpg, from about 2500 sfpg to about 100 sfpg, from about 1000 sfpg to about 100 sfpg, from about 5000 sfpg to about 250 sfpg, from about 2500 sfpg to about 250 sfpg, or from about 1000 sfpg to about 200 sfpg. The number of applications in succession may also vary depending on the soil and the penetration of the composition into the soil. The composition may be applied at least one time. This may include from 1 to 100 successive applications, from 1 to 50 successive applications, from 1 to 10 successive applications, from 3 to 100 successive applications, from 3 to 50 successive applications, or from 3 to 10 successive applications.

The size of the colloidal particles, the size distribution of the colloidal particles, the coating of the colloidal particles, and the presence of polymers and additives to the compositions all impact the rate of penetration of the composition into the soil. Generally, larger and/or coated particles or compositions with polymeric additive penetrate more slowly, but due to slower reaction rates, they penetrate more deeply. Accordingly, such compositions are generally applied first. Small or uncoated nanosilica particles or those compositions with lesser additives or no polymer additive are applied later to react more quickly at the surface of the soil.

Para. 1. A method of treating soil includes applying a composition to soil to form a treated soil, wherein the composition comprises nanosilica particles in an aqueous suspension, and the treated soil exhibits reduced erosion, shrinkage, swelling and increased unconfined compressive and shear strength compared to soil that has not been treated with the composition.

Para. 2. The method of Para. 1, wherein the composition further comprises a polymer.

Para. 3. The method of Para. 1 or 2, wherein the nanosilica particles exhibit a particle size from about 1 nm to about 1000 nm.

Para. 4. The method of Para. 3, wherein the nanosilica particles exhibit a particle size from about 10 nm to about 500 nm.

Para. 5. The method of any one of Paras. 1-4, wherein the nanosilica particles have a shape that is spherical, elliptical, cylindrical, or irregular.

Para. 6. The method of any one of Paras. 1-5, wherein the nanosilica particles are present from about 1 wt % to about 50 wt % of the total weight of the composition.

Para. 7. The method of any one of Paras. 1-6, wherein the nanosilica particles are coated.

Para. 8. The method of Para. 7, wherein the nanosilica particles are at least partially coated with alumina.

Para. 9. The method of any one of Paras. 1-8, wherein the aqueous suspension further comprises a solvent surfactant, silicate, hydrophobic material, degreaser, dispersant, stabilizer, polymer, carbon nanotube, graphene, or a combination of any two or more thereof.

Para. 10. The method of any one of Paras. 1-9, wherein applying the composition comprises applying a first nanosilica composition having a first nanosilica particle size prior or with to a second nanosilica composition having a second nanosilica particle size, wherein the first nanosilica particle size is larger than the second nanosilica particle size.

Para. 11. The method of any one of Paras. 1-10, wherein applying the composition comprises applying a coated nanosilica composition prior to or with a non-coated nanosilica composition.

Para. 12. The method of any one of Paras. 2-11, wherein the polymer is a polycarbonate, a poly(meth)acrylate, a glycol ether, a poly-carboxylate comb polymer, or a mixture of any two or more thereof.

Para. 13. The method of any one of Paras. 1-12, wherein the aqueous suspension further comprises a solvent comprising a glycol ether, alcohol, ketone, or a combination of any two or more thereof.

Para. 14. The method of any one of Paras. 1-13, wherein the applying comprises injecting or mixing the composition into the soil.

Para. 15. A nanosilica composition for application to soil, the composition comprising nanosilica particles in an aqueous suspension and a polymer, wherein the nanosilica particles exhibit a particle size from about 1 nm to about 1000 nm, and the nanosilica particles are present from about 1 wt % to about 50 wt % of the total weight of the composition.

Para. 16. The nanosilica composition of Para. 15, wherein the nanosilica particles exhibit a particle size from about 10 nm to about 500 nm.

Para. 17. The nanosilica composition of Para. 15 or 16, wherein the nanosilica particles have a shape that is spherical, elliptical, cylindrical, irregular, or a combination of any two or more thereof.

Para. 18. The nanosilica composition of any one of Paras. 15-17, wherein the nanosilica particles are coated.

Para. 19. The nanosilica composition of any one of Paras. 15-18, wherein the nanosilica particles are at least partially coated with alumina.

Para. 20. The nanosilica composition of any one of Paras. 15-20, wherein the polymer is a polycarbonate, a poly(meth)acrylate, a glycol ether, a poly-carboxylate comb polymer, or a mixture of any two or more thereof.

Para. 21. The nanosilica composition of any one of Paras. 15-21, wherein the aqueous suspension further comprises a solvent comprising a glycol ether, alcohol, ketone, or a combination of any two or more thereof.

The present invention, thus generally described, will be understood more readily by reference to the following examples, which are provided by way of illustration and are not intended to be limiting of the present invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, cach range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A method of treating soil, the method comprising applying a composition to soil to form a treated soil, wherein the composition comprises nanosilica particles in an aqueous suspension, and the treated soil exhibits reduced erosion, shrinkage, swelling and increased unconfined compressive and shear strength compared to soil that has not been treated with the composition.

2. The method of claim 1, wherein the composition further comprises a polymer.

3. The method of claim 1, wherein the nanosilica particles exhibit a particle size from about 1 nm to about 1000 nm.

4. The method of claim 3, wherein the nanosilica particles exhibit a particle size from about 10 nm to about 500 nm.

5. The method of claim 1, wherein the nanosilica particles have a shape that is spherical, elliptical, cylindrical, or irregular.

6. The method of claim 1, wherein the nanosilica particles are present from about 1 wt % to about 50 wt % of the total weight of the composition.

7. The method of claim 1, wherein the nanosilica particles are coated.

8. The method of claim 7, wherein the nanosilica particles are at least partially coated with alumina.

9. The method of claim 1, wherein the aqueous suspension further comprises a solvent surfactant, silicate, hydrophobic material, degreaser, dispersant, stabilizer, polymer, carbon nanotube, graphene, or a combination of any two or more thereof.

10. The method of claim 1, wherein applying the composition comprises applying a first nanosilica composition having a first nanosilica particle size prior or with to a second nanosilica composition having a second nanosilica particle size, wherein the first nanosilica particle size is larger than the second nanosilica particle size.

11. The method of claim 1, wherein applying the composition comprises applying a coated nanosilica composition prior to or with a non-coated nanosilica composition.

12. The method of claim 2, wherein the polymer is a polycarbonate, a poly(meth)acrylate, a glycol ether, a poly-carboxylate comb polymer, or a mixture of any two or more thereof.

13. The method of claim 1, wherein the aqueous suspension further comprises a solvent comprising a glycol ether, alcohol, ketone, or a combination of any two or more thereof.

14. The method of claim 1, wherein the applying comprises injecting or mixing the composition into the soil.

15. A nanosilica composition for application to soil, the composition comprising nanosilica particles in an aqueous suspension and a polymer, wherein the nanosilica particles exhibit a particle size from about 1 nm to about 1000 nm, and the nanosilica particles are present from about 1 wt % to about 50 wt % of the total weight of the composition.

16. The nanosilica composition of claim 15, wherein the nanosilica particles exhibit a particle size from about 10 nm to about 500 nm.

17. The nanosilica composition of claim 15, wherein the nanosilica particles have a shape that is spherical, elliptical, cylindrical, irregular, or a combination of any two or more thereof.

18. The nanosilica composition of claim 15, wherein the nanosilica particles are coated.

19. The nanosilica composition of claim 18, wherein the nanosilica particles are at least partially coated with alumina.

20. The nanosilica composition of claim 15, wherein the polymer is a polycarbonate, a poly(meth)acrylate, a glycol ether, a poly-carboxylate comb polymer, or a mixture of any two or more thereof.
